(19) United States
(12) Patent Application Publication
(10) Pub. No.: US 2003/0130955 A1
(43) Pub. Date: Jul. 10, 2003

(54) Secure transaction systems

(76) Inventor: William McMullan Hawthorne, Dartmouth (GB)

Correspondence Address: David P Gordon, 65 Woods End Road, Stamford, CT, 06905, US

(21) Appl. No.: 10/168,207

(22) PCT Filed: Dec. 18, 2000
(86) PCT No.: PCT/GB00/04864

(30) Foreign Application Priority Data
Dec. 17, 1999 (GB) 9929723.6
May 19, 2000 (GB) 0012011.2
Oct. 3, 2000 (GB) 0024097.8

(51) Int. Cl. G06F 17/60

(52) U.S. Cl. 705/65

(57) ABSTRACT

A bank card transaction system comprises a first apparatus (10) for use by a card holder and a second apparatus (18) for use by the card issuer. One of these apparatus (e.g. the card holder's apparatus) is arranged for creating an encrypted number, corresponding to at least part of a card number, and the other apparatus is arranged for decrypting the encrypted number upon receipt thereof. The encrypted number is given to the merchant by the card holder, e.g. over the Internet, and is then passed by the merchant to the card issuer for authorisation in the usual way: identifying information is passed over a separate communication link established direct from the card holder to the issuer, to enable the card issuer to decrypt the encrypted card number upon receipt.

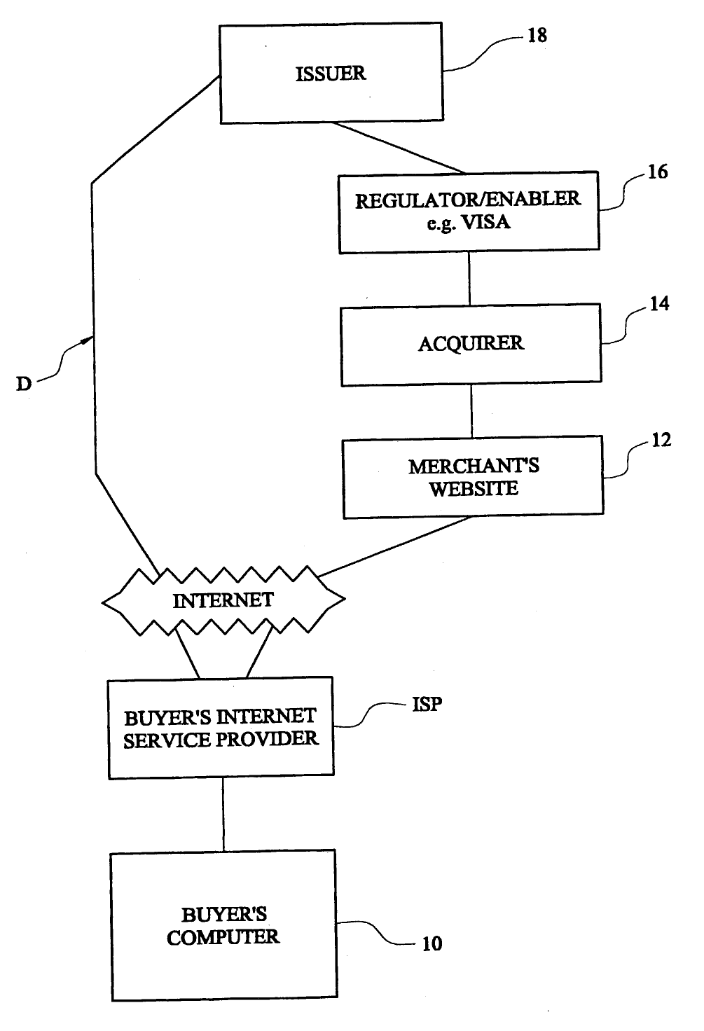

The present invention relates to systems for use to effect transactions in a secure manner: in particular, the invention relates to systems for use when effecting transactions, whether on-line or off-line, using bank cards, (including credit cards,debit cards and charge cards); further, the invention relates to systems for use when effecting transactions, whether on-line or off-line, using bank cards (including credit cards, debit cards and charge cards); moreover, the invention relates to systems for use when effecting on-line transactions with a service-providing organisation, such as a bank, utility company etc.

Each of the above transactions currently lacks security, in that information supplied by a customer can be re-used by anyone who comes into possession of it.

Considering bank cards in particular, conventionally these are used in a variety of ways, as follows:

1) Off-line, the original method used in shops, petrol stations and other retail outlets. The merchant produces a docket by taking an impression of the buyer's card, and the buyer signs this docket to provide authentication and agreement to the transaction. The merchant may obtain authorisation for payment, by telephone or datalink, from the card issuer;

2) On-line, by reading the required information from the magnetically encoded stripe of the card and communicating this information, together with the value of the purchase, to the card issuer to obtain authorisation for the transaction;

3) On-line, by communicating the order and delivery information together with card details over the Internet;

4) By post, by filling in a coupon with the order and delivery information together with card details; and

5) By telephone, the order and delivery information together with card details being given orally over the telephone.

Each of the above methods lacks security, in that the information supplied by the buyer can be re-used by anyone who comes into possession of it, to make fraudulent purchases against the buyer's card.

We have now devised systems for ensuring security in respect of purchases or transactions carried out using bank cards.

In accordance with the present invention, there is provided a bank card transaction system which comprises a first apparatus for use by a card holder and a second apparatus for use by the card issuer, one of said apparatus being arranged for creating an encrypted number, corresponding to at least part of a card number, and the other said apparatus being arranged for decrypting the encrypted number upon receipt thereof.

Preferably the card itself is of conventional form, enabling it to be used in any of the conventional ways discussed above. However, where the system in accordance with the present invention is available to both the card holder and the card issuer, then the card can be used for a secure transaction to be carried out, the true card number not being divulged to the merchant or to any party other than the card issuer.

In a preferred embodiment, for use in performing transactions over the Internet, the card holder's apparatus is arranged to generate a random number which forms part of the card number passed to the merchant: we will call this random number part a transaction number. Typically the card number which is transmitted to the merchant consists of 16 digits, made up of an initial e.g. 6 digits identifying the card issuer, followed by the transaction number (e.g. 8 digits), followed by an e.g. 2- or 1-digit check sum. The card number received by the merchant is passed on by him to the card issuer, typically via his card acquirer and the card regulator (e.g. VISA or MASTERCARD). The card holder's apparatus also initiates a communication direct to the card issuer and transmits, over this link, the same “card number” (or the transaction number) in encrypted form, together with information to identify the card holder (e.g. a reference number for the card holder): the card issuer's apparatus is thus able to identify the card holder and retrieve information, from its customer records, to decrypt the encrypted “card number”.

In a modified or second embodiment, the card issuer's apparatus may be arranged to generate a random transaction number, encrypt this and pass the encryption to the card holder: the card holder's system decrypts the encrypted transaction number and includes the random transaction number, in plain, in a one-time “card number” transmitted to the merchant and onwards to the card issuer, for checking against the random transaction number earlier generated.

In a third embodiment, the card holder is provided with a supplementary card number identifying his card: we will call this card number an alternative card number and it is used only for transactions in accordance with the invention. Thus, the alternative number is an identifying number provided to the card holder in addition to the usual card number (which continues to be used for conventional transactions). Indeed, the account may be set up specifically for electronic transactions, without necessarily issuing a card, in which case the alternative number identifies the account, or a virtual card, rather than a real card. Nevertheless, the alternative number has the same number of digits as a conventional bank card, consisting typically 6 digits identifying the card issuer, followed by 8 digits identifying the card holder, and finally 2 digits serving as a check sum.

In use in effecting a transaction, the alternative number is sent to the merchant and passed on by the merchant to the card issuer, for authorisation in the usual way. In order to provide for security, however, the card holder or buyer's computer is arranged to establish communication direct with the card issuer, bypassing the merchant and card regulator. Over this link, the card holder's computer sends the alternative number (or the account-identifying part thereof) in encrypted form. The apparatus or system at the card issuer decrypts the encrypted alternative number (or part thereof) which it receives direct from the card holder: the issuer's system is then able to confirm that the buyer is in the process of effecting a transaction, and accordingly processes the request for authorisation being made by the merchant, on the basis of the same alternative number.

The card holder or buyer's system also transmits information in plain to the card issuer, in addition to the encrypted form of the alternative number (or card-identifying part thereof), so that the card issuer is able to identify the card holder and so retrieve data from its own customer records to enable it to decrypt the encrypted number. This information may comprise a reference number for the card holder.

In a fourth embodiment, the card holder's apparatus encrypts the unique part of the card number and passes the reconstructed card number to the merchant, together with information to identify the card holder (such as his reference number): all of these items of data are passed on by the merchant to the card issuer. The apparatus at the card issuer is arranged to decrypt the encrypted part of the card number, and so recover the true card number: the recovered card number is then authenticated against the card number held in the card issuer's file for the card holder. The card issuer's apparatus then checks the value of the proposed transaction against the card holder's financial status and so authorise the transaction, and record the transaction against the card holder's account.

In each of the above embodiments, preferably the encryption key is different for each transaction. Accordingly, whilst an unauthorised person may gain possession of the information relating to one transaction, this information cannot be used again, because the card number encryption will be inapplicable for such further uses. The variation of the encryption key may be derived by augmenting it with a salt, which may be the date and time generated from a time clock of the apparatus used for performing the card number encryption, or a random number generated by that apparatus. The use of the salt ensures that the encryption key is substantially different each time it is used. The salt is transmitted together with the encrypted number, to permit decryption of the latter.

When issuing new cards, preferably the apparatus at the card issuer is arranged to generate, for each new card holder, a Unique Personal Key. Preferably this is generated from a master key and from one or more items of open information related to the card holder, for example selected from the card holder's reference number, name, address, telephone number, bank account number, card expiry date, etc. Preferably the card issuer's apparatus is arranged to encrypt the Unique Personal Key using an access PIN or password for the card holder. The card is sent to the card holder: also the encrypted Unique Personal Key is sent to the card holder and (preferably separately) the access PIN or password is sent to the card holder.

Preferably the card holder's apparatus is arranged to allow the card holder to change his access PIN or password as and when desired: in particular, the card holder will normally wish to change his initial access PIN immediately after receiving this from the card issuer. For this purpose, preferably the apparatus is arranged to authenticate the current PIN and only then call up the stored encrypted Unique Personal Key, decrypt this with the correctly-entered current access PIN or password, then re-encrypt this with a newly-entered access PIN or password: the newly encrypted Unique Personal Key is then stored in place of the previous encryption.

In carrying out each transaction, the apparatus used by the card holder is arranged to use the access PIN or password, when entered correctly by the card holder, to decrypt the encrypted Unique Personal Key. Preferably this apparatus is arranged to use the Unique Personal Key and the above-mentioned salt for encryption or decryption purposes.

The apparatus at the card issuer is arranged to recover the card holder's Unique Personal Key, either by retrieving it from the card holder's file using the reference number or other identifying information, or by recreating it from the master key and the relevant items of information used to create it initially. Then the apparatus is able to use the recovered Unique Personal Key and the salt in order to decrypt the encrypted number which it receives during the course of the transaction.

We have also devised systems for ensuring security in respect of transactions carried out on-line between customers and a service-providing organisation (e.g. a bank for on-line banking).

Thus also in accordance with the present invention there is provided a transaction system for performing on-line transactions, between an organisation and a customer thereof, the system comprising a first apparatus for use by a customer and a second apparatus for use by the organisation, one of said apparatus being arranged for creating an encrypted number, corresponding to at least part of a customer number, and the other said apparatus being arranged for decrypting the encrypted number upon receipt thereof.

Embodiments of the present invention will now be described in more detail, by way of examples only, partly with reference to the accompanying drawing, the single figure of which is a schematic diagram to explain a secure transaction over the Internet in accordance with one embodiment of the invention.

For a new card holder, the card issuing authority creates a card which carries the holder's name, the card number and the card expiry date, all this information being embossed on the card and in human-readable form. In common with present practice, the card number consists of 16 digits, the first 6 digits identifying the card issuing authority, the next 8 digits being unique to the card holder, and the final 2 digits being a check sum. The card may include a magnetically encoded stripe and optionally a chip, and also an area for the card holder's signature. The card is accordingly of conventional form and may be used in all the conventional ways: the card issuing authority also generates a conventional PIN number to enable conventional use of the card, for example in a cash machine.

In addition, an electronic apparatus at the card issuing authority is arranged to create a Unique Personal Key for the card holder. This Unique Personal Key (typically 48 to 96 digits in length) is generated from a master key (typically 960 digits in length) together with one or more items of information related to the card holder, such as a reference number for the card holder, the card holder's name, address, telephone number, card number and expiry date.

The electronic apparatus at the card issuing authority is also arranged to generate an initial access PIN number or password for the card holder (in addition to the PIN required for conventional use of the card).

The card issuing authority sends the card to the card holder and also sends the card holder software for running the system, together with a reference number for the card holder, the encrypted Unique Personal Key and preferably the encrypted card number: the software and data items may be sent on-line or on a CD, for example. Preferably separately, the card issuing authority sends the card holder a note of the initial access PIN or password.

In accordance with conventional practice, apparatus at the card issuer stores a card account file for the card holder, which includes the card holder's reference number, name and address, telephone number, bank account number, card number, card expiry date, credit rating etc. This apparatus may or may not store the Unique Personal Key, according to the card issuer's policy. The initial access PIN or password is not stored.

In order to increase the security of the master key, a number of such keys may be in use at any one time. For example, the Unique Personal Key for cards having a first expiry date would be generated from master key 1, cards having the second expiry date would be generated from master key 2, and so on. If each card has an expiry date 2 years after its date of issue and successive expiry dates are one month apart, for example, then there would be 24 master keys in use at any one time. The first master key would become redundant at the end of the first expiry month, and so on. It will be appreciated that the card holder's Unique Personal Key and initial access PIN or password change with each re-issue of his card.

For placing an order over the Internet, the card holder uses, in his PC, the software and other information which was supplied to him. The software requires the card holder to enter his access PIN or password: if this PIN or password is accepted, the software enables the card holder to proceed with placing the order. It will be noted that the card holder's access PIN or password is used by his PC to permit him to proceed and place an order over the Internet, but also serves to decrypt the encrypted Unique Personal Key. The card holder's security software enables the card holder to change his access PIN or password as and when desired: in particular, the card holder will normally wish to change his initial access PIN or password immediately after first receiving this from the card issuing authority.

Referring to the drawing, the card holder's computer 10 is connected to the Internet via his Internet service provider ISP and over the Internet to the merchant's website 12. In the usual manner, the card holder, acting as buyer, visits the merchant's website in order to ascertain the goods or services on offer and the prices of these. The buyer proceeds to place an order: when he elects to pay, he is required to enter his credit or debit card details and the merchant obtains authorisation from the card issuer 18, typically via a card acquirer 14 and the card regulator 16.

In accordance with the present invention, the card holder's security software is arranged to generate an 8-digit random number, which we will call a transaction number. In the Internet transaction under consideration, at the point in the procedure that the card holder (as purchaser or buyer) decides to pay, he confirms this by performing an appropriate keystroke or using the mouse to click on an appropriate box on the screen. Then his security software causes a reconstructed 16-digit “card number” to be sent to the merchant, and onwards to the card issuer 18 in the conventional manner (i.e. via his Internet service provider ISP and the merchant's website 12 and possibly, as in the example shown, via the acquirer 14 and card regulator 16). However, the reconstructed “card number” which is sent from the card holder's computer 10 consists of the usual initial 6 digits identifying the card issuer, followed by the randomly generated 8-digit transaction number, followed finally by a 2-digit check sum (resulting from the check sum algorithm run on the preceding 14 digits). In the usual manner, the card holder's software causes his computer 10 to send his name and card expiry date.

After terminating the connection with the merchant, the card holder's security software causes his computer to initiate a connection D directly to the card issuer 18, bypassing the merchant's website 12 and the traffic handling stations (acquirer and regulator). The card holder's security software encrypts the random transaction number, using the card holder's Unique Personal Key and a salt, then transmits the encrypted transaction number directly to the card issuer 18. The card holder's software may similarly encrypt, and transmit direct to the card issuer, one or more other items of information, e.g. selected from the card holder's name, the true card number, the account reference number, and a message sequence number. In addition, the card holder's security software causes the computer 10 to transmit; in plain, both an open identifier (e.g. the card holder's reference number) to enable the card issuer's system to identify the card holder, and the salt. From the reference number or other identifier, the card issuer's system is able to retrieve or recreate the card holder's Unique Personal Key to enable it, with the salt, to decrypt the encrypted transaction number and any other encrypted information transmitted to it from the card holder's PC. The card issuer's system then adds the transaction number and other information to a record of transactions which it is ready to process.

Upon receipt of the “card number” in the usual way from the merchant's website 12, the card issuer's system makes a comparison between the 8-digit transaction number in this and its record of transaction numbers which it is ready to process. If there is a match, then the card issuer's system proceeds to process the proposed transaction in the conventional manner.

The card issuer's system may be required firstly to process the encrypted transaction number received direct from the card holder (or buyer), before receiving the usual request from the merchant. Instead or in addition, the card issuer's system may be arranged that, if it receives the transaction request first from the merchant, it holds this request until it has received and processed the communication direct from the buyer.

In the above-described arrangement, a predetermined digit of the transaction number may be of a predetermined value, to distinguish the reconstructed card number from a true card number.

Preferably, as described, the transaction number encryption is salted and the salt is transmitted in plain by the card holder's computer 10 direct to the card issuer 18. The salt is variable and most conveniently may comprise a date and time stamp generated by the card holder's PC.

In a second embodiment of the system for effecting a transaction over the Internet, again the software of the card holder's or buyer's PC 10 initiates the second communication link D direct to the card issuer 18, after the buyer has decided to effect payment to the merchant: the buyer's software causes his PC to transmit, in plain, the card or account holder's reference number or other information to identify him. In response, the card issuer's system 18 generates a random 8-digit transaction number to be used as a one-time number and encrypts this using the card holder's Unique Personal Key (retrieved from the system's file for the card holder or recreated from his reference number, name, card number and expiry date and other information and the master key, as previously described): this encrypted transaction number, preferably prefaced with the usual 6 digits identifying the card issuer and followed by the usual 2-digit check sum, is transmitted over the link D to the card holder's computer, together with the salt (preferably a date and time stamp and/or a random number) used in the encryption. The card holder's software decrypts the encrypted transaction number, using the card holder's Unique Personal Key and the salt, and transmits a one-time “card number” to the merchant in plain, consisting of the 6 digits identifying the card issuer, the 8-digit random transaction number and a final 2-digit check sum. This one-time number is handled in the same way as an ordinary card number and is passed on by the merchant 12 to the card issuer 18, typically via the acquirer 14 and regulator 16, together with the card expiry date and transaction value. The card issuer 18 checks whether the 8-digit transaction number, in the one-time card number thus received from the merchant, matches the random number with it generated for the transaction and, in the event of a match, proceeds to process the proposed transaction.

In the above-described embodiments, the data communicated by the merchant 12 to the card issuer 18 is no greater than the data presently communicated over this route(essentially consisting of a 16-digit “card number”, card expiry date and the value of the proposed transaction).

As an additional security measure in each of the above-described embodiments, preferably the value of the proposed transaction is also communicated direct to the card issuer 18, for checking with the payment value requested by the merchant 12. Preferably the transaction value is encrypted (using the Unique Personal Key and the salt).

As a further measure, the software in the card holder's computer 10 is preferably arranged to perform a hash function on the order, the resulting hash being typically of 4 or 6 digits: this hash is then transmitted, in plain, to the merchant 12 and, in encrypted form, direct to the card issuer 18, where it is stored. If subsequently a dispute arises between the buyer and the merchant in respect of any aspect of the transaction (e.g. the product type or number of products or price), then the issuer is able to arbitrate on the basis of the stored hash.

In a third embodiment, which also uses a direct communication link D to the card issuer 18 in addition to the communication link to the merchant, the card holder is issued with a supplementary card number, which we will call an alternative card number, in addition to the usual or true card number provided for conventional transactions. The alternative card number may be provided to the card holder by inclusion in the software provided to him, or may be provided in some alternative secure manner and then entered by the card holder into his computer 10. The alternative card number has 16 digits, like a true card number: also like a true card number, the first 6 digits of the alternative card number identify the card issuer and the final two digits represent a check sum (resulting from the predetermined checking algorithm run on all the preceding digits). The middle 8 digits form the transaction number.

Thus, in carrying out a transaction over the Internet, then the alternative card number is sent by the card holder's computer 10 to the merchant and onwards to the card issuer 18. Also, the transaction number from the alternative card number is encrypted using the card holder's Unique Personal Key and a random salt and transmitted, direct to the card issuer 18, together with the card holder's reference number and the salt in plain. The card issuer's system 18 is able to identify the card holder from the reference number and so is able to retrieve or recreate his Unique Personal Key. Using the recovered Unique Personal Key and the salt, the card issuer's system 18 then decrypts the encrypted transaction number. The card issuer's system 18 is then ready to authorise the transaction and adds the transaction number to its record of transactions which it is ready to process, as described previously.

Each of the above-described embodiments may be used for placing an order or effecting a transaction with the merchant off-line. Thus, the card holder will communicate direct with the card issuer on-line in the manner described above, for each embodiment, but the information which the merchant requires from the card holder is given to the merchant off-line (e.g. over the telephone or through the post or at a point-of-sale) rather than on-line.

A fourth embodiment of the invention, for placing an order over the Internet, will now be described. In this embodiment, the software in the card holder's PC initiates the transmission, to the merchant, of the first 6 digits of the true card number (to identify the card issuing authority) followed by an 8-digit encryption of the next 8 digits of the card number, followed by a 2-digit check sum. The intermediate 8-digits of the card number are encrypted using the Unique Personal Key and a salt. The software also causes the card holder's reference number and the salt to be transmitted in plain to the merchant, together with the card expiry date.

The electronic processing apparatus at the merchant is arranged to pass on, to the card issuer, information consisting of the card holder's reference number, the salt, the card expiry date, and the 16 digit “card number” which now includes the encryption of the intermediate 8-digits of the true card number.

Upon reception of the above information, the apparatus at the card issuer uses the card holder's reference number, from the received information, to retrieve or recreate the card holder's Unique Personal Key. The apparatus now uses the recovered Unique Personal Key and the received salt in order to decrypt the 8-digit encrypted part of the card number. The apparatus is arranged, in accordance with conventional practice, to provide authentication by checking the decrypted card number against the true card number held in the card holder's file. Then the proposed purchase or transaction is checked against the card holder's current credit status in order to authorise the transaction, and the transaction is recorded in the card holder's account. The card issuer's apparatus furthermore stores, in its file for the card holder, either the salt used for the transaction, or the 8-digit encrypted part of the card number, or both the salt and the 8-digit encrypted part of the card number.

In addition to use for placing an order over the Internet or by other electronic communication, the above-described fourth embodiment may be used for placing an order or effecting a transaction with the merchant off-line, particularly ordering over the telephone or through the postal services or at a point-of-sale. In such cases, the card holder uses his PC to run the security software, firstly to log on using his access PIN or password in the manner described above. Then the security software causes the PC to recover the Unique Personal Key, using the holder's access PIN or password: then the security software causes the PC to encrypt the 8-digit unique part of the holder's card number, using the recovered Unique Personal Key and a salt, as described above; the PC then displays and/or prints out the encrypted card number and the salt. The card holder is now able to place an order orally over the telephone, preferably quoting his reference number, name, card expiry date, the salt and the encrypted card number. Alternatively, the card holder may write this information on an order form, for posting, faxing or otherwise communicating to the merchant. The merchant enters the received information into his system, which then passes on, to the card issuer, the card holder's reference number, the salt, card expiry date and “card number”, for processing in the manner described above.

The card holder may, if he wishes, generate a number of card number encryptions and corresponding salts, all in one session, for the purpose of placing a succession of orders as and when required.

Instead of requiring the use of a PC, the card holder may be supplied with a portable device, preferably a hand-held device, programmed to perform the security calculations for the card holder. Thus, the device includes a memory for storing the encrypted Unique Personal Key and the card number. The device requires the card holder to enter his access PIN or password to enable the device: then the card holder uses the device to generate a card number encryption and output this together with the salt which is used. The device may have a time clock or random number generator, which is used for deriving the salt. The device is also arranged to enable the card holder to change his access PIN or password in the manner described above.

The bank card may be in the form of a smart card which includes a chip which stores the card holder's reference number, encrypted Unique Personal Key and other relevant information. The card may then be used with a host machine, for example a cash machine or a point-of-sale register, which requires the card holder to insert his card and enter his access PIN or password, following which the machine firstly verifies the access PIN, decrypts the Unique Personal Key and then generates the encrypted card number and corresponding salt. The cash machine then communicates the card holder's reference number and the salt to the card issuer, together with the encrypted card number and any other relevant information. The card issuer uses the reference number to identify the card holder and so retrieve or recreate this Unique Personal Key, then uses this and the salt to decrypt the encrypted card number, for checking against the true card number held in its file for the card holder. If this matches, then the transaction is allowed to proceed.

Each of the four embodiments described above may be used for on-line transactions over the Internet, for example between a card or account holder and a bank. Thus, the card or account holder's computer would in such cases communicate directly with the bank or other financial institution issuing the card or holding the account (this institution corresponding to, or in some cases being the same party as, the card issuer shown in the drawing). In each of the four embodiments, all communication is with the financial institution, rather than with any merchant. The card holder's software is arranged, on establishing communication with the financial institution, to transmit the card holder's reference number so that the financial institution can identify the card holder. The four embodiments would be arranged to operate as follows.

In the first embodiment, the random transaction number (or “card number” including the random transaction number) is transmitted, together with the salt, and also the encrypted transaction number (or “card number”): the system at the financial institution recovers the Unique Personal Key and uses this, with the salt, to decrypt the encrypted transaction number, for comparison with the transaction number received in plain; if there is a match, the transaction is allowed to proceed.

In the second embodiment, the system at the financial institution uses the card holder's reference number to recover his Unique Personal Key, and uses this and a salt to encrypt a random transaction number, which is sent (with the salt) to the card holder: the card holder's computer uses his Unique Personal Key and the salt to decrypt the transaction number, which is then sent back in plain to the financial institution for comparison with the transaction number originally generated there.

In the third embodiment, the card holder's computer sends the encrypted alternative card number and a salt to the financial institution: using the card holder's reference number, the system at the financial institution recovers the Unique Personal Key and uses this, with the salt, to decrypt the alternative number and compare this with the alternative number held in its file for the card holder.

In the fourth embodiment, the card holder's computer sends the encrypted true card number and a salt: the system at the financial institution uses the card holder's reference number to recover his Unique Personal Key then uses this, with the salt, to decrypt the encrypted true card number, for checking against that held in its file for the card holder.

Whilst the above description relates to on-line bank transactions, the respective embodiments may be used, in corresponding manner, for on-line transactions between a customer and any service-providing organisation (e.g. a utility company, the tax office, etc) in which he has an account or customer number. In such cases, the customer number replaces the “card number” referred to in the above description.

1. A bank card transaction system which comprises a first apparatus for use by a card holder and a second apparatus for use by the card issuer, one of said apparatus being arranged for creating an encrypted number, corresponding to at least part of a card number, and the other said apparatus being arranged for decrypting the encrypted number upon receipt thereof.

2. A system as claimed in claim 1, arranged for providing a card number to a merchant to effect a transaction, and also arranged to establish separate communication with the card issuer's apparatus.

3. A system as claimed in claim 2, further comprising apparatus for use by the merchant and arranged for providing said card number, received from the card holder, to the card issuer.

4. A system as claimed in claim 2 or 3, in which the card holder's apparatus is arranged randomly to generate a transaction number to form part of a card number for provision to the merchant, the card holder's apparatus being further arranged to encrypt the transaction number or card number and transmit the encrypted number to the card issuer's apparatus.

5. A system as claimed in claim 4, in which the card holder's apparatus is arranged to transmit one or more items of information to the card issuer's apparatus, to enable the latter to identify the card holder.

6. A system as claimed in claim 2 or 3, in which the card issuer's apparatus is arranged randomly to generate a transaction number which it then encrypts and transmits to the card holder's apparatus, and the card holder's apparatus is arranged to decrypt the encrypted transaction number and then include the transaction number in a one-time card number for provision to the merchant.

7. A system as claimed in claim 2 or 3, arranged for provision of an alternative card number to the merchant, the card holder's apparatus being arranged to encrypt the alternative number or a part thereof and transmit the encrypted number to the card issuer's apparatus.

8. A system as claimed in any one of claims 2 to 7, in which the card holder's apparatus is arranged to transmit the value of the transaction to the card issuer's apparatus.

9. A system as claimed in claim 8, in which the card holder's apparatus is arranged to transmit the value of the transaction in encrypted form.

10. A system as claimed in any one of claims 2 to 9, in which the card holder's apparatus is arranged to perform a hash function on the order placed with the merchant, and transmit this to the card issuer and optionally to the merchant.

11. A system as claimed in claim 1, in which the card holder's apparatus is arranged to encrypt part of the holder's card number and provide a reconstructed card number, which includes the encrypted part, to the merchant, together with one or more items of information identifying the card holder.

12. A system as claimed in claim 11, further comprising apparatus for use by the merchant and arranged for providing said reconstructed card number and said identifying information to the card issuer.

13. A system as claimed in any preceding claim, arranged such that the encryption is performed using a key which is augmented by a salt, the salt being transmitted with the encrypted number.

14. A system as claimed in any preceding claim, in which the card holder's apparatus holds, in encrypted form, a Unique Personal Key for the card holder, and said card holder's apparatus is arranged to decrypt this upon entry of a password or PIN, the decrypted unique personal key then being used as encryption or decryption key.

15. A system as claimed in claim 13, in which the card issuer's apparatus is arranged to recreate the card holder's Unique Personal Key, at each transaction, for use as decryption or encryption key.

16. Apparatus for use by a card holder in a system as claimed in claim 1, the apparatus being arranged for creating or decrypting an encrypted number, corresponding to at least part of a card number.

17. Apparatus for use by a card issuer in a system as claimed in claim 1, the apparatus being arranged for creating or decrypting an encrypted number, corresponding to at least part of a card number.

18. A transaction system for performing on-line transactions, between an organisation and a customer thereof, the system comprising a first apparatus for use by a customer and a second apparatus for use by the organisation, one of said apparatus being arranged for creating an encrypted number, corresponding to at least part of a customer number, and the other said apparatus being arranged for decrypting the encrypted number upon receipt thereof.

19. A transaction system as claimed in claim 18, in which said first apparatus is arranged to generate a transaction number to form part of a customer number for transmission to said second apparatus, and said first apparatus is also arranged to encrypt said transaction number or customer number and transmit said encrypted number to said second apparatus.

20. A system as claimed in claim 18, in which said first apparatus is arranged to transmit one or more items of information to said second apparatus, to enable the latter to identify the customer.

21. A system as claimed in claim 18, in which second apparatus is arranged randomly to generate a transaction number which it then encrypts and transmits to said first apparatus, and said first apparatus is arranged to decrypt the encrypted transaction number and then transmit the transaction number in plain to said second apparatus.

22. A system as claimed in claim 18, said second apparatus is arranged to perform the encryption using a key which is augmented by a salt, the salt being transmitted with the encrypted number.

23. A system as claimed in claim 18, in which said first apparatus holds, in encrypted form, a Unique Personal Key for the customer, and said first apparatus is arranged to decrypt this upon entry of a password or PIN, the decrypted Unique Personal Key then being used as encryption or decryption key.

24. Apparatus for use by a customer in a system as claimed in claim 18, the apparatus being arranged for creating or decrypting an encrypted number, corresponding to at least part of a respective customer number.

25. Apparatus for use by a service-providing organisation in a system as claimed in claim 18, the apparatus being arranged for creating or decrypting an encrypted number, corresponding to at least part of a respective customer number.
